(19) United States
(12) Patent Application Publication
(10) Pub. No.: US 2025/0256288 A1
(43) Pub. Date: Aug. 14, 2025

(54) Separation Device Comprising a Magnetic Separation Unit and Fluid Separation Method

(71) Applicant: Respired Limited, London (GB)

(72) Inventors: Siamak R. Ardkapan, Søborg (DK); Matthew S. Johnson, Lund (SE)

(21) Appl. No.: 19/185,401

(22) Filed: Apr. 22, 2025

Related U.S. Application Data
(63) Continuation of application No. PCT/EP2023/076046, filed on Sep. 21, 2023.

(30) Foreign Application Priority Data
Oct. 28, 2022 (DK) PA 2022 00981

(51) Int. Cl. B03C 1/30

(52) U.S. Cl. CPC B03C 1/30

(57) ABSTRACT

A fluid separation unit that comprises a housing having an inlet port for receiving a fluid, an outlet port for discharging fluid and a conduit extending between the inlet port and the outlet port is disclosed. The fluid separation unit comprises at least one permanent magnet arranged to attract magnetic or magnetizable particles in the fluid. The at least one permanent magnet is at least partly covered by a magnetizable covering structure. A flow entrainment section is arranged inside the housing. The flow entrainment section is arranged and configured to reduce the velocity of a portion of the fluid by at least 50% and recirculate fluid inside the conduit.

### CROSS-REFERENCE TO RELATED APPLICATIONS

This application is a continuation under 35 U.S.C. 111 of International Patent Application No. PCT/EP 2023/076046, filed Sep. 21, 2023, which claims the benefit of and priority to Danish Application No. PA 2022 00981, filed Oct. 28, 2022, each of which is hereby incorporated by reference in its entirety.

### FIELD OF INVENTION

The present invention relates to a fluid separation unit comprising a magnetic filtering unit that is capable of removing ferromagnetic particles from a fluid. The present invention also relates to a fluid filtration method for removing ferromagnetic particles from a fluid.

### BACKGROUND

Humans are exposed to ferromagnetic particles in many places where they work and commute [Wang, J., Li, S., Li, H., Qian, X., Li, X., Liu, X., Lu, H., Wang, C. and Sun, Y., 2017. Trace metals and magnetic particles in PM2. 5: Magnetic identification and its implications. Scientific reports, 7 (1), pp. 1-11.]. At high concentrations, ferromagnetic particles are found in metro and train stations [N. Kappelt, H. S. Russell, D. Fessa, O. Hertel and M. S. Johnson, Particulate Air Pollution in the Copenhagen Metro Part 1: Mass Concentrations and Ventilation, Environment International, 2022 and Smith, J. D., Barratt, B. M., Fuller, G. W., Kelly, F. J., Loxham, M., Nicolosi, E., Priestman, M., Tremper, A. H. and Green, D. C., 2020. PM2. 5 on the London Underground. Environment international, 1, p. 105188]. These particles are found in high concentrations in steel workshops and foundries as well.

Mechanical fibrous filters can remove particles, but the energy usage is high due to the high-pressure drop over the filter [S. Kwiatkowski, M. Polat, W. Yu and M. S. Johnson, Industrial Emissions Control Technologies: Introduction, In: Meyers R. (eds) Encyclopedia of Sustainability Science and Technology, Springer, New York, NY, 2019, https://doi.org/10.1007/978-1-4939-2493-6_1083-1.]. Mechanical filters remove particles by blocking the passing particles. Therefore, the fiber structure should be very tight to capture the particles following the airflow.

There have been some attempts to use magnetic fields to remove ferromagnetic particles. For example, environmental researchers sometimes quantify the fraction of airborne particulate matter that is attracted by magnetic fields [Castaneda-Miranda, A. G., Böhnel, H. N., Molina-Garza, R. S. and Chaparro, M. A., 2014. Magnetic evaluation of TSP-filters for air quality monitoring. Atmospheric environment, 96, pp. 163-174.]. While electrostatic precipitators based on static electrical charges and electrophoresis are known [S. Kwiatkowski, M. Polat, W. Yu and M. S. Johnson, Industrial Emissions Control Technologies: Introduction, In: Meyers R. (eds) Encyclopedia of Sustainability Science and Technology, Springer, New York, NY, 2019, https://doi.org/10.1007/978-1-4939-2493-6_1083-1], relatively little is known about using magnetophoresis as the basis of filtration. One of the problems of the existing solutions is that the magnetic fields do not effectively trap particles due to high-velocity particles, and the Clean Air Delivery Rate (CADR) of such systems is low considering the energy input.

JP 2019209298 A discloses an air filter configured to adsorb and remove magnetic dust such as iron powder. The air filter is arranged in an air intake port of electric equipment. The air filter comprises permanent magnets arranged oppositely to sandwich air flow passing through the air intake port, and a magnetic filter arranged between the permanent magnets. The magnetic filter is made of thin wires made of magnetic materials. This filter tends to clog as magnetic or magnetizable particles are caught by the magnetic filter. Hereby, an increased pressure difference is required to force air through the magnetic filter and thus the efficiency of the filter is significantly reduced.

US20140367340A1 discloses a magnetic particle separator suitable for separating magnetic and non-magnetic particles from a thermal fluid flowing in a heating system. The magnetic particle separator comprises a hollow body configured with an upper particle separation chamber and for circulation of the thermal fluid between an inlet and an outlet port. A quieting chamber exists beneath the particle separation chamber for accumulation of the particles separated from the fluid. An annular support element for permanent magnets is removably fastened outside the quieting chamber of the separator. The energy efficiency of this filter, however, is poor. Accordingly, it would be desirable to have an alternative to this solution.

U.S. Pat. No. 4,529,517 A discloses an arrangement for cleaning a liquid containing particles, particularly for removing particles or objects such as magnetite, iron shavings, rust, etc., which can be attracted by magnetic fields and are contained in the liquid. The liquid is guided to traverse a magnetic field produced by a magnet placed separate from the liquid. At least one body which distributes the magnetic field in the liquid is provided in or near the flow path of the liquid. This body is designed as a removable plug combined with an aperture which is formed in the liquid container, and a further body which distributes the magnetic field is orientated on the outside of the liquid container. This solution is, however, neither practical nor efficient with respect to energy consumption.

U.S. Pat. No. 2,798,611 A discloses a magnetic separator comprising a liquid-tight housing adapted to be coupled into a fluid conduit, said housing having a fluid inlet and a fluid outlet passage extending in the same direction within the upper portion thereof, one said passage having a terminal end concentrically arranged within, but at a level above the level of the terminal end of the other passage and magnetic means within said housing. The magnetic means including an upwardly directed magnetic face at a spaced uniform distance opposite to and below the level of the terminal end of the encircled passage, said upwardly directed magnetic face extending transversely of the terminal end portion of the encircling passage over an area larger than the area of the terminal end of the encircled passage and adapted to reverse a stream issuing therefrom annularly around said stream in cooperation with said encircling passage. This solution is, however, neither practical nor efficient with respect to energy consumption.

Accordingly, there is a need for an apparatus which is to provide an alternative fluid separation unit while aiming at reducing or even eliminating the above-mentioned disadvantages of the prior art, and a method for using the apparatus.

### BRIEF DESCRIPTION

A fluid separation unit according to the present disclosure is a fluid separation unit comprising:
a housing having an inlet port for receiving a fluid, an outlet port for discharging fluid and a conduit extending between the inlet port and the outlet port;
at least one permanent magnet arranged to attract magnetic or magnetizable particles in the fluid, wherein the at least one permanent magnet is one of a plurality of permanent magnets of a magnetic assembly and is at least partly covered by a magnetizable covering structure, wherein a flow entrainment section is arranged inside the housing, wherein in the flow entrainment section a magnetic assembly is provided, wherein the magnetic assembly comprises a plurality of parallel rod-shaped permanent magnets that are covered by a magnetizable metal section,
the conduit comprises a main channel extending along the longitudinal axis of the housing,
the housing is configured so that most of the fluid entering the main channel flows along a straight path from the inlet port to the outlet port,
the outlet port has a larger width D₄ than the width D₂ of the inlet port, the flow entrainment section comprises an inner wall and an outer wall, wherein the inner wall is a converging diverging-nozzle configured to allow the fluid to pass through and to create, together with the outer wall, a bypass channel,
the flow entrainment section is configured so that a portion of the fluid is sucked into the bypass channel and so that said portion of the fluid is recirculated into the main channel of the conduit after it has passed through the magnetic assembly.

Hereby, it is possible to provide a fluid separation unit that does not clog as easily as the prior art fluid separation units. Moreover, it is possible to provide a fluid separation unit having an improved efficiency.

The fluid separation unit is configured to filter a flow of a liquid or a gas or a combination thereof.

The housing may be made of various materials including plastic, wood, metal and ceramic materials. The housing comprises an inlet port for receiving a fluid, an outlet port for discharging fluid and a conduit extending between the inlet port and the outlet port.

At least one permanent magnet of the plurality of permanents magnets is arranged to attract magnetic or magnetizable particles in the fluid.

The at least one permanent magnet of the plurality of permanents magnets is at least partly covered by a magnetizable covering structure. In an embodiment, the magnetizable covering structure is made of steel. In an embodiment, the magnetizable covering structure is made of stainless steel.

In an embodiment, the flow entrainment section is arranged and configured to reduce the velocity of a portion the fluid by at least 50% and recirculate that portion of the fluid inside the conduit.

In an embodiment, the flow entrainment section is arranged and configured to reduce the velocity of a portion the fluid by at least 60%.

In an embodiment, the flow entrainment section is arranged and configured to reduce the velocity of a portion the fluid by at least 70%.

In an embodiment, the flow entrainment section is arranged and configured to reduce the velocity of a portion the fluid by at least 80%.

In an embodiment, the flow entrainment section is arranged and configured to reduce the velocity of a portion the fluid by at least 85%.

In an embodiment, the flow entrainment section is arranged and configured to reduce the velocity of a portion the fluid by at least 90%.

The magnetic or magnetizable particles may include ferromagnetic particles.

The current devices and methods use the least amount of energy to remove ferromagnetic particles compared to the existing technologies and, therefore, can be applied in spaces such as train/metro stations and steel workshops as an energy-efficient solution.

In an embodiment, the at least one permanent magnet extends (basically) along the direction of the flow of the inside the flow entrainment section. Hereby, the time for attracting and catching the magnetic or magnetizable particles can be maximized.

In an embodiment, the length of the at least one permanent magnet is at least 2 cm.

In an embodiment, the length of the at least one permanent magnet is at least 2.5 cm.

In an embodiment, the length of the at least one permanent magnet is at least 3 cm.

In an embodiment, the length of the at least one permanent magnet is at least 3.5 cm.

In an embodiment, the length of the at least one permanent magnet is at least 4 cm.

In an embodiment, the length of the at least one permanent magnet is at least 5 cm.

In an embodiment, the housing comprises:
a first part constituting an arched portion;
a second part constituting an arched portion and a straight portion;
a cylindric front portion comprising the inlet port; and
a conical outlet portion comprising the outlet port,
   wherein the first part is sandwiched between the front portion and the second part and the second part is sandwiched between the first part and the outlet portion, wherein the width of the first part is larger than the width of the second part.

In an embodiment, the at least one permanent magnet is arranged in the second part.

In an embodiment, the width of the front portion is smaller than the width of the outlet portion.

In an embodiment, the flow entrainment section is designed as a ring extending in the conduit along the inner wall of a portion of the first part and the second part.

In an embodiment, the distal portion of the low velocity reducing section comprises a conical inner wall.

In an embodiment, the volume of the flow entrainment section is less than 1000 ml.

In an embodiment, the volume of the flow entrainment section is less than 900 ml.

In an embodiment, the volume of the flow entrainment section is less than 800 ml.

In an embodiment, the volume of the flow entrainment section is less than 700 ml.

In an embodiment, the volume of the flow entrainment section is less than 600 ml.

In an embodiment, the volume of the flow entrainment section is less than 500 ml.

Since the magnetic force decreases by the cube of the distance, it may be an advantage to keep the ducts through which fluid passes in the magnetizable structure and/or magnetizable portion small. Accordingly, it may be an advantage to keep the volume of the flow entrainment section below a predefined level e.g. 1000 ml.

In an embodiment, the proximal portion of the low velocity reducing section comprises an inwardly arced inner wall.

In an embodiment, the proximal portion of the low velocity reducing section comprises an inwardly arced and concave inner wall.

In an embodiment, the magnetic assembly comprises a plurality of ducts arranged along the periphery of a portion of the housing, wherein each duct comprises one or more rod-shaped permanent magnets extending along the longitudinal axis of the duct, wherein each permanent magnet is covered by a magnetizable covering structure.

In an embodiment, a plurality of parallel rod-shaped permanent magnets are covered by a magnetizable metal section.

A method according to the present disclosure removes magnetic or magnetizable particles using a fluid separation unit disclosed herein. The method comprises the step of reducing the velocity of a portion the fluid and recirculating that portion of the fluid inside the conduit, wherein in the flow entrainment section a magnetic assembly is provided, wherein the magnetic assembly comprises a plurality of parallel rod-shaped permanent magnets that are covered by a magnetizable metal section.

Hereby, it is possible to provide a method for removing magnetic or magnetizable particles in an improved manner. The methods can significantly increase the time before the fluid separation unit clogs. Moreover, the method has an improved performance (a lower pressure difference is required to force a fluid through the fluid separation unit).

In an embodiment, the at least one permanent magnet extends basically along the direction of the flow inside the flow entrainment section.

In an embodiment, the at least one permanent magnet extends along the direction of the flow inside the flow entrainment section.

In an embodiment, the length of the at least one permanent magnet is at least 2 cm.

In an embodiment, the fluid separation unit comprises a flow entrainment section comprising a magnetic assembly that comprises a plurality of parallel rod-shaped permanent magnets that are covered by a magnetizable metal section.

In an embodiment, the method comprises the step of reducing the velocity of a portion the fluid by at least 50% and recirculating that portion of the fluid inside the conduit.

In an embodiment, the distal portion of the low velocity reducing section comprises a conical inner wall.

In an embodiment, the volume of the flow entrainment section is less than 1000 ml.

In an embodiment, the proximal portion of the low velocity reducing section comprises an inwardly arced (concave) inner wall.

In an embodiment, the magnetic assembly comprises a plurality of ducts arranged along the periphery of a portion of the housing, wherein each duct comprises one or more rod-shaped permanent magnets extending along the longitudinal axis of the duct, wherein each permanent magnet is covered by a magnetizable covering structure.

In an embodiment, a plurality of parallel rod-shaped permanent magnets are covered by a magnetizable metal section.

### BRIEF DESCRIPTION OF THE DRAWINGS

The devices and methods will become more fully understood from the detailed description given herein below. The accompanying drawings are given by way of illustration only, and thus, they are not limitative of the present devices and methods. In the accompanying drawings:

FIG. 1A shows a cross-sectional side view of a fluid separation unit according to an embodiment;

FIG. 1B shows a side view of the fluid separation unit shown in FIG. 1A;

FIG. 2 shows a prior art air filter device for removing ferromagnetic particles from air;

FIG. 3 shows a magnetic assembly of a fluid separation unit according to an embodiment;

FIG. 4 shows a cross-sectional side view of a magnetic assembly of a fluid separation unit according to an embodiment;

FIG. 5A shows a front view of a magnetic assembly of a fluid separation unit according to an embodiment;

FIG. 5B shows a permanent magnet and the surrounding magnetizable structure of the magnetic assembly shown in FIG. 5A;

FIG. 6A shows a front view of a magnetic assembly of a fluid separation unit according to an embodiment;

FIG. 6B shows a permanent magnet and the surrounding magnetizable structure of the magnetic assembly shown in FIG. 6A;

FIG. 7A shows a front view of a magnetic assembly of a fluid separation unit according to an embodiment;

FIG. 7B shows a plurality of permanent magnets and the surrounding magnetizable structures of the magnetic assembly shown in FIG. 7A;

FIG. 8A shows a perspective side view of a fluid separation unit according to an embodiment; and

FIG. 8B shows a perspective side view of a fluid separation unit corresponding to the one shown in FIGS. 1A and 1n FIG. 1B.

### DETAILED DESCRIPTION

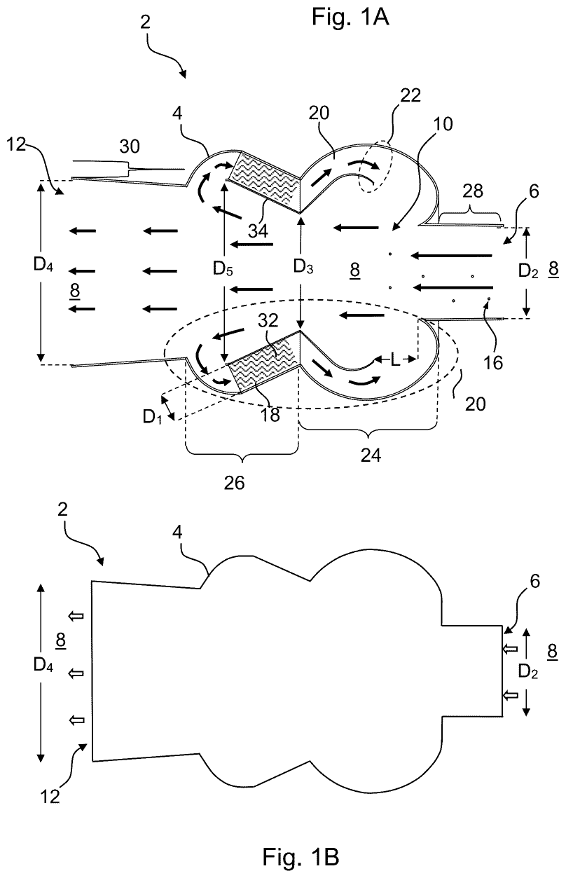

Referring now in detail to the drawings for the purpose of illustrating embodiments of the present devices and methods, a fluid separation unit 2 is illustrated in FIG. 1.

FIG. 1 illustrates a cross-sectional side view of a fluid separation unit 2 according to an embodiment. The fluid separation unit 2 comprises a housing 4 having an inlet port 6 for receiving a fluid 8, an outlet 30 comprising an outlet port 12 for discharging fluid 8 and a conduit 10 extending between the inlet port 6 and the outlet port 12.

In an embodiment, the fluid separation unit 2 is configured to filter air. In an embodiment, the fluid separation unit 2 is configured to filter a liquid (e.g. water).

The fluid separation unit 2 comprises a plurality of permanent magnets (not shown) arranged to attract magnetic or magnetizable particles 16 in the fluid 8. The permanent magnets are at least partly covered by a magnetizable covering structure 18.

The fluid separation unit 2 comprises a flow entrainment section 20 arranged inside the housing 4. The flow entrainment section 20 is arranged and configured to reduce the velocity of a portion of the fluid 8 and recirculate fluid inside the conduit 10. In an embodiment, the flow entrainment section 20 is arranged and configured to reduce the velocity of a portion of the fluid 8 with by least 50%.

Inside the central portion of the housing 4 a main channel of the conduit 10 extends along the longitudinal axis of the housing 4. A fluid 8 (e.g. air) enters the housing 4 via the inlet port 6. The inlet port has a width D₂ large enough to receive a predefined desired flow (e.g. 1-10 L/min) of the fluid 8. When the fluid 8 has entered the main channel, most of the fluid continues along a straight path, through which the fluid 8 leaves the housing 4 through an outlet port 12 having a larger width D₄ than the width D₂ of the inlet port 6. Hereby, the velocity of the fluid 8 is continuously reduced from the inlet port 6 to the outlet port 12. Section 20 acts as an entraining flow section.

A minor percentage of the fluid (e.g. 10%) 8 will, however, be sucked into a flow entrainment section 20. The flow entrainment section 20 comprises a first portion 24 and a second portion 26. The second portion comprises an arched part arranged next to a straight part. A magnetic assembly 32 comprising a plurality of permanent magnets (not shown) being at least partly covered by a magnetizable covering material 18 is arranged in the straight part of the second portion.

The first portion 24 comprises a straight part and an arched portion 22. The straight part of the first portion 24 is arranged next to the straight part of the second portion 26. The arched portion 22 of the first portion is configured to guide the fluid 8 that has passed through the magnetic assembly 32 to be recirculated into the main channel of the conduct 10.

The magnetic field generated by the magnetic assembly 32 will attract metal particles from the flow passing from the conduit 10. Hereby, the efficiency of the fluid separation unit 2 can be increased.

The flow entrainment section 20 comprises an inner wall and an outer wall. The inner wall is a converging-diverging nozzle configured to allow the fluid 8 to pass through and, together with the outer wall, creates the bypass channel. The main flow enters the nozzle from the inlet port 6 and entrains the fluid molecules from the bypass fluid flow.

The nozzle outlet area A_{nozzle} outlet is given by width D₅ of the nozzle outlet:

$${A}_{nozzle outlet } = {π ( 1 / 2 {D}_{5} )}^{2} \qquad ( 1 )$$

A_{nozzle} outlet will typically be between 0.8 to 1.2 times the area A_{outlet port} of the outlet port 12.

$${A}_{outlet port} = {π ( 1 / 2 )}^{2} \qquad ( 2 )$$

The narrow area of the nozzle has an area A_{narrow nozzle} that is larger than the area A_{inlet port} of the inlet port 6 but smaller than the area A_{nozzle} outlet of the outlet port.

$${A}_{narrow nozzle} = {π ( 1 / 2 {D}_{3} )}^{2} \qquad ( 3 )$$

$${A}_{inlet port} = {π ( 1 / 2 {D}_{2} )}^{2} \qquad ( 4 )$$

The distance L between the inlet region of the conduit 10 and the inlet of the nozzle is between 40% to 60% of the inlet's effective width. The effective width is the area A_{inlet port} of the inlet port 6 squared.

Therefore, the fluid pressure gradually increases along the center channel of the conduit 10 due to the increase in the cross-sectional area. The lowest pressure value can be found at the end of the nozzle (in which the width is D₅) due to the flow, which induces a wake at this point.

The width D₁ of the magnetic assembly 32 is indicated. The width D₁ of the magnetic assembly 32 is smaller than half the width D₂ of the inlet port 6. Typically, the width D₁ of the magnetic assembly 32 corresponds to 25-40% of the width D₂ of the inlet port 6. In an embodiment, the width D₁ of the magnetic assembly 32 corresponds to 30-35% of the width D₂ of the inlet port 6.

The inlet port 6 is designed as a cylindrical portion. The outlet port 12, however, is conical. The distal end of the outlet port 12 is larger than the proximal end of the outlet port 12. Accordingly, the velocity of the fluid 8 will gradually be reduced as indicated by the arrows indicating the velocity of the fluid 8. The cross-sectional area of the outlet port 12 will typically be 2 to 7 times the cross-sectional area of the inlet port 6.

In an embodiment, the width D₄ of the outlet port 12 is more than 50% larger than the width D₂ of the inlet port 6.

In an embodiment, the magnetic assembly 32 consists of a multi-channel duct, wherein one or more permanent magnets are arranged in each duct.

In an embodiment, the fluid separation unit 2 may comprise a ventilator arranged to provide a pressure differential that can suck fluid 8 into the inlet port 6 of the fluid separation unit 2 and/or outlet cleaned fluid 8 out through the outlet port 12.

The fluid separation unit 2 comprises a front portion 28 comprising the inlet port 6. The front portion 28 may be straight or conical. By having a front portion 28, it is possible to achieve a fully developed velocity profile (a homogeneous flow along the cross section of the end portion of the front portion 28). If front portion 28 is removed, the velocity profile would not be homogeneous as the central portion having largest distance to the wall would have significantly higher velocity than the regions near the wall.

FIG. 1B illustrates a side view of the fluid separation unit 2 shown in FIG. 1A. The fluid separation unit 2 comprises a housing 4 having an inlet port 6 and an outlet port 12. The inlet port 6 has a width D₂ and the outlet port 12 has a larger width D₄. A fluid 8 enters the inlet port and exits the fluid separation unit 2 via the outlet port 12.

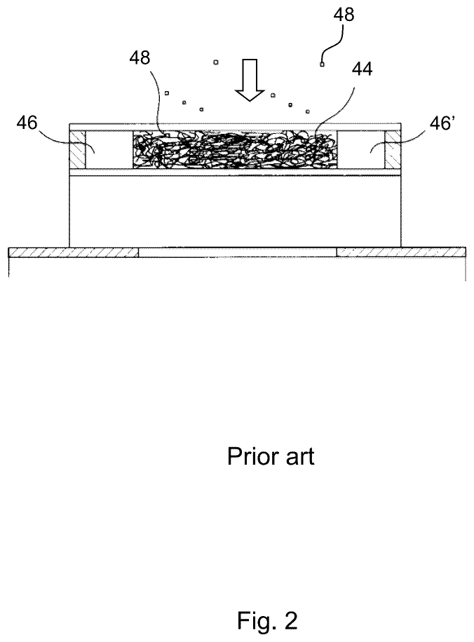

FIG. 2 illustrates a prior art air filter device for removing ferromagnetic particles 48 from air. The prior art air filter device comprises several permanent magnets 46, 46′ and a magnetizable material 44. The magnetizable material 44, which is typically steel wool is arranged between adjacent magnets 46, 46′. Accordingly, the magnetizable material 44 is magnetized and capable of attracting ferromagnetic particles 48 from air. It, however, is important to both have a low flow velocity and a high density of the magnetizable material 44 to be able to catch the ferromagnetic particles 48 from air because the extension of the magnetizable material 44 along the flow path is quite small. Accordingly, the prior art air filter device will get clogged quite easily. Moreover, a large pressure is required to pass the magnetizable material 44. Therefore, it is desirable to have a filter device that is more efficient (requires less pressure) and does not get clogged quite as easily.

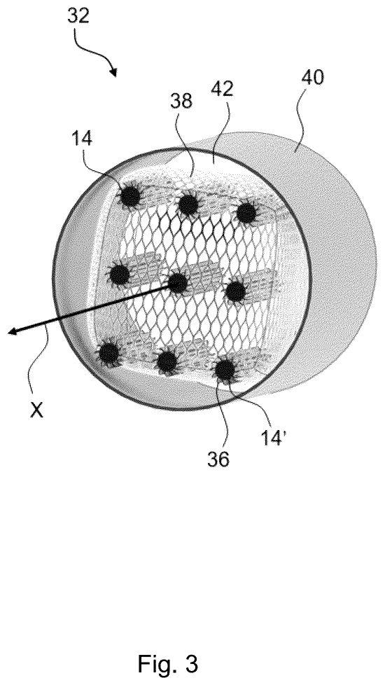

FIG. 3 illustrates a magnetic assembly 32 of a fluid separation unit according to an embodiment. The magnetic assembly 32 comprises a cylindrical duct 40 having a longitudinal axis X. A plurality of rod-shaped permanent magnets 14, 14′ extend along the longitudinal axis X. Since the flow direction extends along the longitudinal axis X, the magnetic assembly 32 is designed to provide the longest possible time to catch magnetic or magnetizable particles in the fluid to be filtered using the magnetic assembly 32.

Each of the permanent magnets 14, 14′ is cylindrical. A magnetizable structure 36 surrounds the axial periphery of each of the permanent magnets 14, 14′. The magnetizable structure 36 may be made of steel. In an embodiment, the magnetizable structure 36 is shaped as steel brushes protruding radially from the periphery of the magnet 14, 14′ that it surrounds.

The magnets 14, 14′ are attached to a magnetizable portion 38 arranged inside the duct 40. In an embodiment, the magnetizable portion 38 is made of steel. In an embodiment, the magnetizable portion 38 is shaped as a grate.

A free space 42 is provided between the inner wall of the duct 40 and the magnetizable portion 38. Fluid passing through the magnetic assembly 32 may travel via the space 42. The magnetic or magnetizable particles in the fluid will, however, be attracted to the magnetizable structure 36 surrounding the axial periphery of each of the permanent magnets 14, 14′. Accordingly, the magnetic or magnetizable particles will, in most cases, get caught (due to the magnetic attraction) and thus removed from the fluid.

Since there is a large space between adjacent magnetizable structures 36. The magnetic assembly 32 has a very large capacity for collecting magnetic or magnetizable particles without getting clogged.

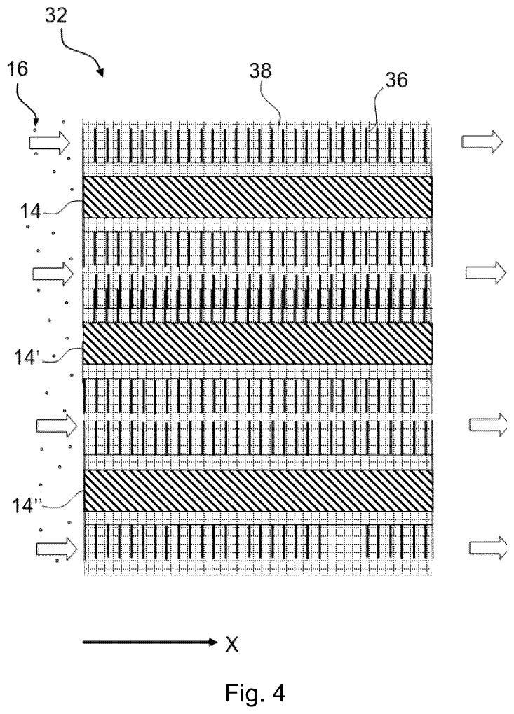

FIG. 4 illustrates a cross-sectional side view of a magnetic assembly 32 of a fluid separation unit according to an embodiment. The magnetic assembly 32 comprises a plurality of parallel cylindrical permanent magnets 14, 14′, 14″. The permanent magnets 14, 14′, 14″ extend along the longitudinal axis X of the magnetic assembly 32.

Each of the permanent magnets 14, 14′, 14″ is surrounded by a magnetizable structure 36. The magnetizable structures 36 are shaped as brushes comprising a plurality of brush members extending radially. The magnetizable structures 36 extend radially from a structure that is in contact with or connected to a structure that is in contact with a magnet 14, 14′. Accordingly, the magnetizable structures 36 are magnetized by the magnets 14, 14′. Therefore, the magnetizable structures 36 will attract and catch magnetic or magnetizable particles in the fluid being filtered.

The magnetizable portion 38 illustrated may optionally be arranged between the brush structures of the magnetizable structures 36 and optionally in at least some of the other spaces of the magnetic assembly 32.

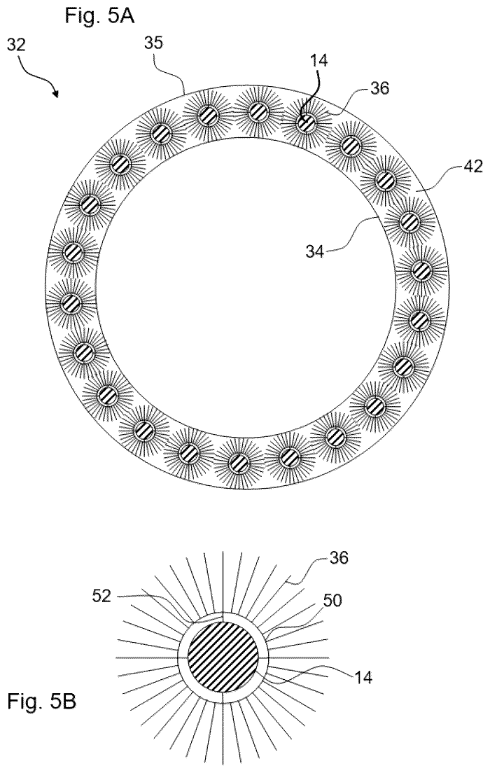

FIG. 5A illustrates a front view of a magnetic assembly 32 of a fluid separation unit according to an embodiment. FIG. 5B illustrates a permanent magnet 14 and the surrounding magnetizable structure 36 of the magnetic assembly 32 shown in FIG. 5A.

The magnetic assembly 32 comprises an inner wall 34 and an outer wall 35. The magnetic assembly 32 comprises a plurality of parallel cylindrical permanent magnets 14. Each of the permanent magnets 14 is surrounded by a magnetizable structure 36 shaped as brushes comprising a plurality of brush members extending radially.

A space 42 is provided between the magnetizable structures 36 and the wall 35 of the magnetic assembly 32.

In FIG. 5B, one can see that the magnetizable structures 36 extend radially from a surrounding portion 50 (surrounding the magnet 14) that is in contact with the magnet 14 via attachment structures 52 extending between the inside of the surrounding portion 50 and the magnet 14. Accordingly, the magnetizable structures 36 are magnetized by the magnet 14. Thus, the magnetizable structures 36 will attract and catch magnetic or magnetizable particles in the fluid being filtered.

It is possible to arrange a magnetizable portion 38 between the structures arranged between the inner wall 34 and the outer wall 35.

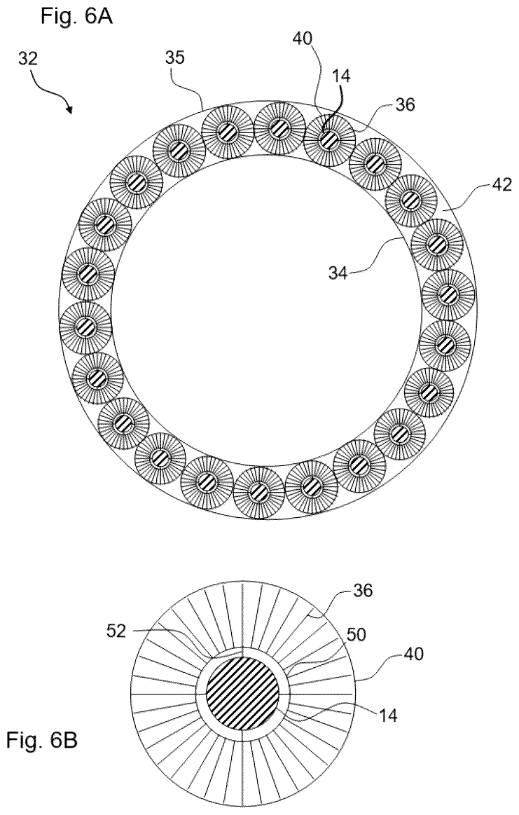

FIG. 6A illustrates a front view of a magnetic assembly 32 of a fluid separation unit according to an embodiment. FIG. 6B illustrates a permanent magnet 14 and the surrounding magnetizable structure 36 of the magnetic assembly 32 shown in FIG. 6A. It is important to emphasize, the permanent magnet 14 may be replaced with an electromagnet. Accordingly, in an embodiment, the magnetic assembly 32 of the fluid separation unit comprises an electromagnet (not shown) surrounded by a magnetizable structure 36 of the magnetic assembly 32.

By having an electromagnet, it is possible to shut off the power and hereby turn off the magnetic field generated by the electromagnet. This may be an advantage when cleaning the filter (removing the collected particles).

The magnetic assembly 32 comprises an inner wall 34 and an outer wall 35. The magnetic assembly 32 comprises a plurality of parallel cylindrical permanent magnets 14. The permanent magnets 14 are surrounded by a magnetizable structure 36 shaped as brushes comprising a plurality of brush members extending radially.

A space 42 is provided between the magnetizable structures 36 and the wall 35 of the magnetic assembly 32. Even though it is not shown, it is possible to arrange a magnetizable portion 38 between the structures arranged between the inner wall 34 and the outer wall 35.

FIG. 6B illustrates that the magnetizable structures 36 extend radially from a surrounding portion 50 (surrounding the magnet 14) that is in contact with the magnet 14 via attachment structures 52 extending between the inside of the surrounding portion 50 and the magnet 14 so that the magnetizable structures 36 are magnetized by the magnet 14. Thus, the magnetizable structures 36 will attract and catch magnetic or magnetizable particles in the fluid being filtered. The magnetizable structure 36 is arranged inside a duct 40.

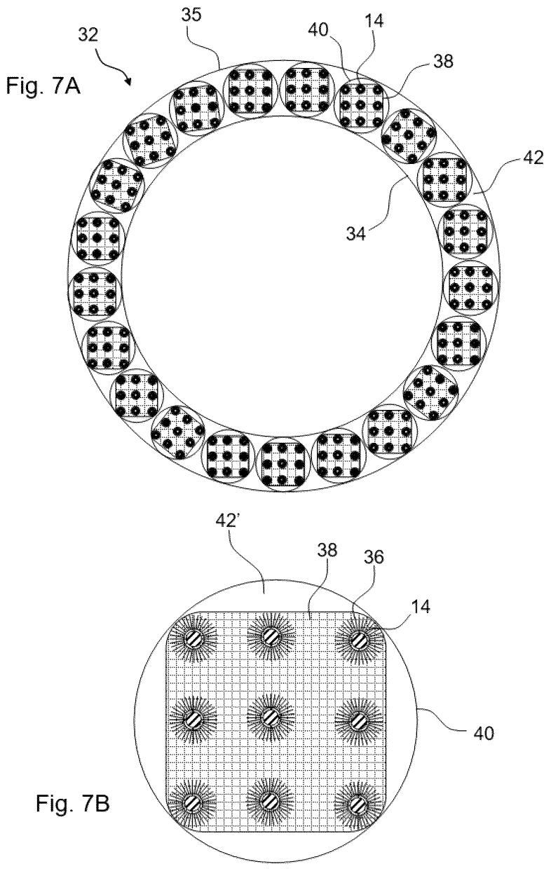

FIG. 7A illustrates a front view of a magnetic assembly 32 of a fluid separation unit according to an embodiment. FIG. 7B illustrates a plurality of permanent magnets 14 and the surrounding magnetizable structures 36 of the magnetic assembly 32 shown in FIG. 7A.

The magnetic assembly 32 comprises an inner wall 34 and an outer wall 35. The magnetic assembly 32 comprises a plurality of ducts 40 corresponding to the one shown in FIG. 7B.

Each duct 40 comprises a plurality of permanent magnets 14 that are surrounded by a magnetizable structure 36 shaped as brushes comprising a plurality of brush members extending radially. The magnets 14 are attached to a magnetizable portion 38. A space 42′ is provided between the magnetizable portion 38 and the inner wall of the duct 40.

A space 42 is provided between the ducts 40 and the wall 35 of the magnetic assembly 32. Even though it is not shown, it is possible to arrange a magnetizable portion between the ducts 40, the inner wall 34, and the outer wall 35.

The brushes shown in and explained with reference to FIG. 5A, FIG. 5B, FIG. 6A, FIG. 6B, FIG. 7A and FIG. 7B are designed to facilitate the capture and removal of ferromagnetic particles from the fluid flow. In this way, the magnetic assembly 32 removes ferromagnetic particles from the flow. The arrows shown in FIG. 1A illustrate the fluid flow directions.

A steel brush provided with cylindrical permanent magnet 14 extending along the central line of the brush, generates a uniform magnetic field. This magnetic field is capable of capturing particles while the fluid 8 can pass the brush hairs with the smallest possible pressure drop. In an embodiment, a magnetizable portion of steel wool is placed between the brushes and around them. Since the magnetic assembly 32 is placed at the diverging part of the nozzle, it can attract the ferromagnetic particles 16 passing through the nozzle and increase the probability of directing them to the bypass channel.

In an embodiment, the fluid separation unit 2 is configured to be installed and applied in train and metro stations to remove ferromagnetic particles from the air.

In an embodiment, the fluid separation unit 2 is configured to be installed in series on the walls or the ceilings of spaces with high ferromagnetic particle concentrations.

In an embodiment, the fluid separation unit 2 is configured to be installed on the body of the trains to remove the ferromagnetic particles from the tunnels' air. Tunnels are full of ferromagnetic particles, and their air enters stations due to the piston effect. Cleaning the air in tunnels by trains can be very effective as the cleaning is close to the pollution source.

In an embodiment, the fluid separation unit 2 is configured to be installed outside of the trains. The fluid separation unit 2 will start removing ferromagnetic particles when trains start braking. The air will pass through the system due to the movement of the train, and therefore, it does not need to have any fan to move air.

In an embodiment, the fluid separation unit 2 is configured to be installed on the walls of train/metro tunnels to remove ferromagnetic particles. The air can move through the fluid separation unit 2 due to the movement of trains, a fan, or any other type of air-moving mechanism.

A fan will typically be used if the device is used as a standalone device. Such standalone device may be installed at a train station or at a wall by way of example.

In an embodiment, the fluid separation unit 2 is configured to be used in combination with mechanical filters, such as fibrous filters, to remove all types of particles from the air of tunnels, stations, steel workshops, or foundries.

In an embodiment, the fluid separation unit 2 is configured to be used with gas removal technologies to remove gas pollutants and particulate matter.

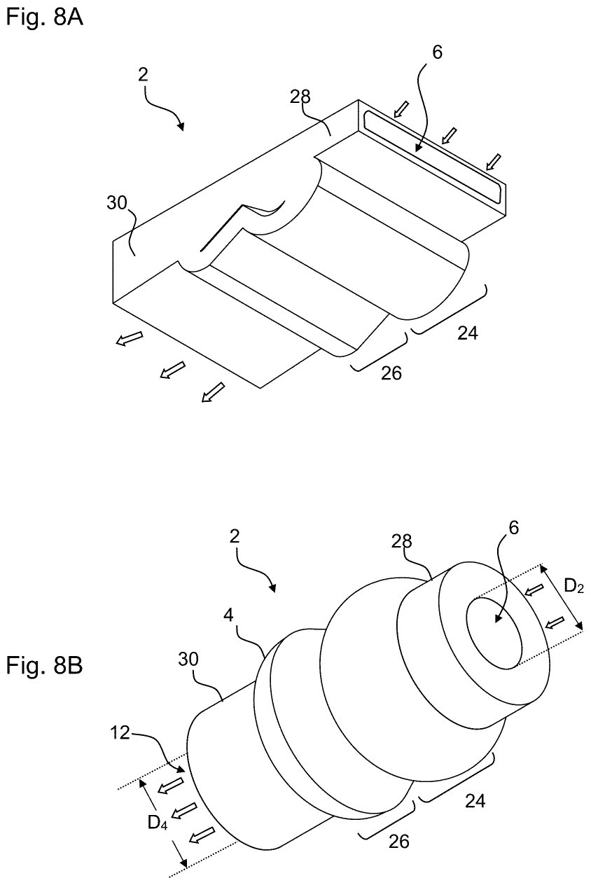

FIG. 8A illustrates a perspective side view of a fluid separation unit 2 according to an embodiment. The fluid separation unit 2 comprises similar features as the fluid separation unit shown in and explained with reference to FIG. 1A. The geometry of the structures is, however, different. The fluid separation unit 2 comprises a housing having a planar bottom surface.

The fluid separation unit 2 comprises a box-shaped front portion 28 shaped as a tubular structure designed to receive the fluid and provide a fully developed velocity profile (a homogeneous flow along the cross section of the end portion of the front portion 28).

The fluid separation unit 2 comprises a flow entrainment section comprising a first portion 24 and a second portion 26. The fluid separation unit 2 comprises an outlet portion 30 designed to discharge fluid.

FIG. 8B illustrates a perspective side view of a fluid separation unit corresponding to the one shown in FIG. 1A and in FIG. 1B. The fluid separation unit 2 comprises a housing 4 having an inlet port 6 for receiving a fluid 8, an outlet 30 comprising an outlet port 12 for discharging fluid 8. The fluid separation unit 2 comprises a conduit extending between the inlet port 6 and the outlet port 12.

The fluid separation unit 2 comprises a flow entrainment section comprising a first portion 24 and a second portion 26. The second portion comprises an arched part arranged next to a straight part (see FIG. 1A).

The first portion 24 comprises a straight part and an arched portion (see FIG. 1A). The straight part of the first portion 24 is arranged next to the straight part of the second portion 26.

### LIST OF REFERENCE NUMERALS

2 Fluid separation unit
4 Housing
6 Inlet port
8 Fluid
10 Conduit
12 Outlet port
14, 14′, 14″, 14″ Permanent magnet
16 Particle
18 Covering structure
20 Flow entrainment section
22 Arched portion
24 First portion
26 Second portion
28 Front portion (tubular structure)
30 Conical portion
32 Magnetic assembly
34 Inner wall
35 Outer wall
36 Magnetizable structure
38 Magnetizable portion
40 Duct
42, 42′ Space
44 Magnetizable material
46, 46′ Permanent magnet
48 Particle
50 Surrounding portion
52 Attachment structure
D₁, D₂, D₃, D₄, D₅ Width
X Axis
L Distance

What is claimed is:

1. A fluid separation unit comprising:
a housing having an inlet port for receiving a fluid, an outlet port for discharging the fluid and a conduit extending between the inlet port and the outlet port;
at least one permanent magnet arranged to attract magnetic or magnetizable particles in the fluid, wherein the at least one permanent magnet is at least partly covered by a magnetizable covering structure, and the at least one permanent magnet is one of a plurality of permanent magnets of a magnetic assembly;
a flow entrainment section arranged inside the housing, wherein in the flow entrainment section the magnetic assembly is provided, the magnetic assembly comprising a plurality of parallel rod-shaped permanent magnets that are covered by a magnetizable metal section,
wherein the conduit comprises a main channel extending along a longitudinal axis of the housing, and the housing is configured so that most of the fluid entering the main channel flows along a straight path from the inlet port to the outlet port, the outlet port having a larger width D₄ than a width D₂ of the inlet port, the flow entrainment section comprising an inner wall and an outer wall, wherein the inner wall is a converging diverging-nozzle configured to allow the fluid to pass through and to create, together with the outer wall, a bypass channel, wherein the flow entrainment section is further configured so that a portion of the fluid is sucked into the bypass channel and so that said portion of the fluid is recirculated into the main channel of the conduit after it has passed through the magnetic assembly.

2. The fluid separation unit according to claim 1, wherein a cross-sectional area of the outlet port is more than 50% larger than a cross-sectional area of the inlet port.

3. The fluid separation unit according to claim 1, wherein at least one of the permanent magnets of the plurality of permanent magnets of the magnetic assembly extends along a direction of flow inside the flow entrainment section.

4. The fluid separation unit according to claim 1, wherein a length of at least one of the permanent magnets of the plurality of permanent magnets of the magnetic assembly is at least 2 cm.

5. The fluid separation unit according to claim 1, wherein the housing comprises:
a first portion of the housing that comprises a minor straight part and a major arched portion;
a second portion that comprises an arched part arranged next to a straight part;
a cylindrical front portion comprising the inlet port; and
a conical outlet portion comprising the outlet port, which is conical;
wherein the first portion is sandwiched between the front portion and the second portion and the second portion is sandwiched between the first portion and the outlet portion, wherein a width of the first portion is larger than a width of the second portion.

6. The fluid separation unit according to claim 5, wherein at least one of the plurality of permanent magnets of the magnetic assembly is arranged in the second portion.

7. The fluid separation unit according to claim 5, wherein a width (D₂) of the front portion is smaller than a width (D₄) of the outlet portion.

8. The fluid separation unit according to claim 5, wherein the flow entrainment section forms a ring extending in the conduit along an inner wall of a portion of the first portion and the second portion.

9. The fluid separation unit according to claim 8, wherein a distal portion of the flow entrainment section, creating a velocity-reducing section, comprises a conical inner wall.

10. The fluid separation unit according to claim 1, wherein a volume of the flow entrainment section is less than 1000 ml.

11. The fluid separation unit according to claim 9, wherein a proximal portion of the flow entrainment section, creating the velocity-reducing section, comprises an inwardly arced inner wall.

12. The fluid separation unit according to claim 5, wherein the magnetic assembly comprises a plurality of ducts arranged along a periphery of said second portion of the housing, wherein each duct comprises one or more rod-shaped permanent magnets extending along a longitudinal axis of the duct, wherein each permanent magnet is covered by a magnetizable covering structure.

13. A method for removing magnetic or magnetizable particles using a fluid separation unit according to claim 5, the method comprising:
reducing the velocity of a portion of the fluid; and
recirculating that portion of the fluid inside the conduit, wherein in the flow entrainment section a magnetic assembly is provided, wherein the magnetic assembly comprises a plurality of parallel rod-shaped permanent magnets that are covered by a magnetizable metal section.

14. The method according to claim 13, wherein the plurality of permanent magnets of the magnetic assembly extends along a direction of the flow inside the flow entrainment section.
